(19) United States
(12) Patent Application Publication
(10) Pub. No.: US 2008/0298203 A1
(43) Pub. Date: Dec. 4, 2008

(54) OPTICAL INFORMATION RECORDING MEDIUM AND METHOD OF FABRICATING THE SAME

(75) Inventors: Motomitsu Hagiwara, Gunma (JP); Takeshi Otsu, Gunma (JP); Akimasa Miyata, Gunma (JP)

Correspondence Address: KNOBBE MARTENS OLSON & BEAR LLP, 2040 MAIN STREET, FOURTEENTH FLOOR, IRVINE, CA, 92614, US

(73) Assignee: Taiyo Yuden Co., Ltd., Tokyo (JP)

(21) Appl. No.: 12/021,924

(22) Filed: Jan. 29, 2008

(30) Foreign Application Priority Data
Jan. 31, 2007 (JP) 2007-020490

(51) Int. Cl. G11B 3/74; B05D 5/06

(52) U.S. Cl. 369/94; 427/162

(57) ABSTRACT

Proposed are a method of fabricating an optical information recording medium that can prevent the degradation of the appearance caused by a hardening resin entering between a center cap and a substrate due to capillary action, and an optical information recording medium using a substrate for implementing the method.

The optical information recording medium has a reflective layer and a recording layer on a first surface of a circular substrate having a through hole in a center part, and an optically transparent cover layer is provided on the recording layer. The substrate has an inner diameter of an area near an opening of the through hole on the first surface greater than that of another portion of the through hole. A step part is formed on the surface on the light incident side, that is, formed around the through hole on the surface on which the reflective layer and the recording layer are formed.

### BACKGROUND OF THE INVENTION

1. Field of the Invention

The present invention relates to a substrate form used for a next generation optical information recording medium such as a Blu-ray disk, and a method of fabricating an optical information recording medium using the same.

2. Description of the Related Art

As an information recording medium, an optical information recording medium such as an optical disk is becoming available rapidly. For an optical information recording medium like this, there is a recording medium in which a reflective layer and a recording layer are formed on an optically transparent resin substrate having a thickness of about 1.2 mm and a diameter of about 120 mm or 80 mm, such as CD-R. In recent years, much higher information recording density has been demanded. In order to reduce the spot diameter to implement high density recording, such a scheme is considered that laser wavelengths are made shorter and an objective lens having a large numerical aperture (NA) is used, and an optical information recording medium such as DVD±R can be implemented. In order to increase an allowance of the tilt angle (tilt) of the disk due to shorter wavelengths and a high numerical aperture, this DVD±R has a structure in which two optically transparent resin substrates having a thickness of 0.6 mm are bonded to each other and a reflective layer and a recording layer are sandwiched between the substrates.

However, in recent years, in order to record high definition video data, much higher information recording density has been demanded. In a Blu-ray disk, for example, such an optical information recording medium is proposed that has a structure in which a reflective layer and a recording layer are formed of the surface on the light incident side of a resin substrate having a thickness of about 1.1 mm and the recording layer is covered with an optically transparent cover layer having a thickness of about 0.1 mm.

In the case of an optical information recording medium like this, such a method is proposed in which a cover layer is formed with an optically transparent ultraviolet curing resin or a radiation curing resin by spin coating, as disclosed in Japanese Patent No. 3762759 (Patent Reference 1) and JP-A-2004-288270 (Patent Reference 2). This method is a scheme in which the through hole in the center part of a substrate is closed with a center cap having nearly a cone shape formed of a metal such as aluminum and a hardening resin is supplied to the center part of the substrate with a nozzle and is applied by spin coating. However, as shown in FIG. 7, the method has a problem that the hardening resin enters the clearance between the substrate and the center cap due to capillary action, causing resin bleeding in the area on the inner side of a rim CG of the center cap, which degrades the appearance of a completed product. Then, for example, as shown in FIG. 8, JP-A-11-066647 (Patent Reference 3) proposes a method in which a taper part is provided in a center cap CC′ to decrease the contact area of the center cap CC′ with a substrate 2′ and a clearance SP is formed between the center cap CC′ and the substrate 2′, whereby a hardening resin is prevented from entering due to capillary action.

In the center cap CC′ provided with the taper part, in order to reduce the contact area with the substrate 2′, the thickness of the rim is thinned. As shown in FIG. 9, for example, when a slope angle θ of the taper part of the center cap CC′ is an angle of 30 degrees or below, a length L of the center cap CC′ contacted with the substrate 2′ is twice as long as a thickness 1 of the taper part of the center cap CC′ or longer. Thus, in order to reduce the contact area, it is necessary to decrease the thickness of 1 correspondingly. It is difficult to fabricate the center cap CC′ like this because there are many process steps of grinding, for example, as well as the strength of the taper part is reduced to tend to cause damage, deformation and abrasion, which causes the necessity of frequent replacement. On this account, there is a problem that the fabrication costs of an optical information recording medium rise.

### SUMMARY OF THE INVENTION

An object of the invention is to propose a fabrication method that can obtain an optical information recording medium at low costs which can prevent the degradation of the appearance caused by a hardening resin entering between a center cap and a substrate due to capillary action, and to propose an optical information recording medium using a substrate for implementing the method.

As a first technical means according to the invention, an optical information recording medium is proposed, the medium including: a substrate in a circular shape having a through hole in a center part; a reflective layer and a recording layer formed on a first surface of the substrate; and an optically transparent cover layer provided on the surface on which the reflective layer and the recording layer are formed, wherein the substrate has an inner diameter of an area near an opening of the through hole on the first surface greater than an inner diameter of the through hole of another portion.

According to the first technical means, a step is formed near the opening of the through hole, and a hardening resin entering the clearance between the substrate and a center cap is stopped by the step. Thus, since the bleeding of the hardening resin is shaped in a circular shape, the appearance of a completed product can be made excellent. In addition, since a center cap before can be used as a center cap, an optical information recording medium with an excellent appearance can be obtained at low costs.

In addition, preferably, the area near the opening of the through hole is an area having a depth of at most about 0.3 mm from the surface of the substrate. Since the through hole is a clamp hole of the optical information recording medium, the force of fixing the medium to a spindle of a recording/reproducing apparatus, for example, becomes small and causes unstable rotations of the optical information recording medium when the depth of the portion having a large inner diameter becomes deep. Therefore, when the depth of the portion having a large inner diameter is within a depth of about 0.3 mm from the surface of the substrate, stable rotations can be obtained.

In addition, the invention proposes a method of fabricating an optical information recording medium including the steps of: preparing a substrate in a circular shape having a through hole in a center part and having a reflective layer and a recording layer formed on a first surface of the substrate; blocking the through hole of the substrate with a center cap and supplying an optically transparent hardening resin to an area near the through hole on the one surface; rotating the substrate to cover the surface on which the reflective layer and the recording layer are formed with the hardening resin by spin coating; and curing the hardening resin to form a cover layer, wherein the substrate has an inner diameter of an area near an opening of the through hole on the first surface greater than an inner diameter of the through hole of another portion and smaller than a diameter of the center cap.

According to the fabrication method, a hardening resin entering the clearance between a substrate and a center cap can be stopped by a step near the opening of the through hole, and the bleeding of the hardening resin can be shaped in a circular shape. Accordingly, the appearance can be made excellent. In addition, since a center cap previously available can be used as a center cap, an optical information recording medium with an excellent appearance can be fabricated at low costs.

According to the invention, the degradation of the appearance can be prevented, which degradation is caused by a hardening resin entering between a center cap and a substrate due to capillary action. In addition, since a center cap previously available can be used as a center cap, an optical information recording medium with an excellent appearance can be readily obtained at low costs.

### BRIEF DESCRIPTION OF THE DRAWINGS

FIG. 1 shows a cross section schematically depicting an optical information recording medium according to the invention;

FIG. 2 shows a cross section schematically depicting the fabrication process step of the optical information recording medium according to the invention;

FIG. 3 shows an enlarged cross section schematically depicting dotted circle A shown in FIG. 2;

FIG. 4 shows a schematic plan view depicting the fabrication process step of the optical information recording medium according to the invention;

FIG. 5 shows a schematic plan view depicting the fabrication process step of the optical information recording medium according to the invention;

FIG. 6 shows a cross section schematically depicting another exemplary substrate of the optical information recording medium according to the invention;

FIG. 7 shows a schematic plan view depicting a problem of a prior optical information recording medium;

FIG. 8 shows a partial cross section schematically depicting the fabrication process step of the prior optical information recording medium; and

FIG. 9 shows an enlarged diagram depicting portion B shown in FIG. 8.

### DETAILED DESCRIPTION OF THE INVENTION

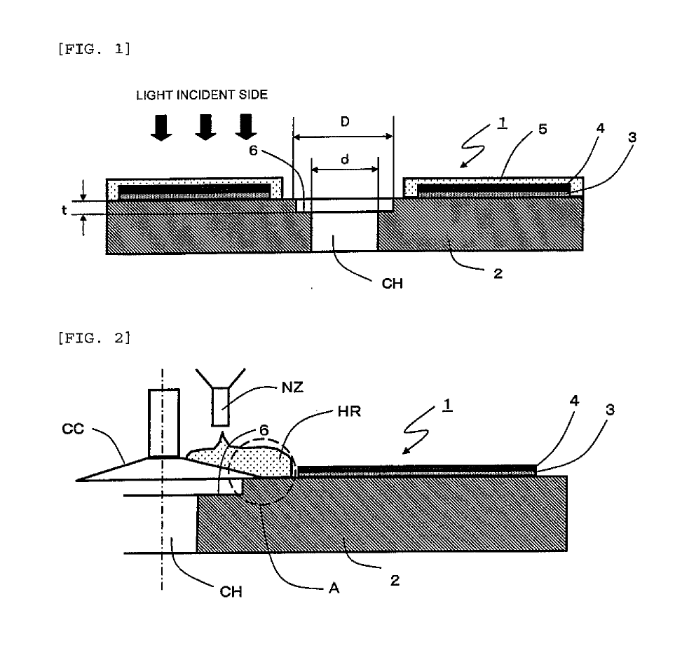

An embodiment of an optical information recording medium according to the invention will be described with reference to the drawings, taking the form of, as an example, a single layer optical disk. FIG. 1 shows a cross section schematically depicting the optical information recording medium according to the invention. This optical information recording medium 1 has a substrate 2 in a circular shape that has a through hole CH in which the center part is the rotational center, a reflective layer 3 that is formed on one surface of the substrate 2, a recording layer 4 that is formed on the reflective layer 3, and an optically transparent cover layer 5 that is provided on the recording layer 4.

The substrate 2 is a resin substrate having a diameter of about 120 mm in which the thickness of the portion formed of the reflective layer 3 and the recording layer 4 is a thickness of about 1.1 mm. For the substrate 2, various materials previously used as the substrate material of the optical information recording medium can be freely selected for use. For example, the following materials can be used: acrylic resins such as polycarbonate and polymethylmethacrylate, vinyl chloride resins such as polyvinyl chloride and vinyl chloride copolymer, epoxy resins, amorphous polyolefins, polyester resins, metals such as aluminum, and glass. These materials may be combined according to methods such as laminating. Among the materials, thermoplastic resins are preferable in view of formability, moisture resistance, stability of dimensions and inexpensiveness, and polycarbonate is particularly preferable.

The area of the substrate 2 near the opening of the through hole CH has an inner diameter D, which is greater than an inner diameter d of the other portion of the through hole CH (for example, in the case of a Blu-ray disk, about 15 mm), whereby a step part 6 is formed on the surface of the light incident side; that is, the step part 6 is formed around the through hole CH on the surface on which the recording layer 4 is formed. Moreover, the inner diameter D of the area near the opening of the through hole CH on the light incident side is formed smaller than the diameter of the center cap for use, preferably, about 15.5 to 23.0 mm. In addition, a depth t of the area near the opening of the through hole CH on the light incident side is about 0.05 mm to about 0.3 mm, preferably about 0.2 mm. With the provision of the depth described above, the fixing force in clamping the medium can be maintained to provide stable rotations.

The reflective layer 3 is formed of a metal thin film such as Ag or Al, and the recording layer 4 is configured of a layer having a cyanine dye or an azo dye, for example. In addition, in order to make the recording layer 4 a rewritable optical information recording medium, a phase change thin film may be used instead of a dye layer. Moreover, in FIG. 1, the recording layer is a single layer. However, for example, a recording layer of a multi-layer structure may be formed in which a semitransparent reflective layer is used to in turn form a first recording layer, a semitransparent reflective layer, a second recording layer, and a reflective layer laminated from the light incident side. In addition, a layer for controlling recording characteristics, improving adhesion, or protecting the recording layer 3 may be formed between the substrate 2 and the reflective layer 3, between the reflective layer 3 and the recording layer 4, or between the recording layer 4 and the cover layer 5.

The cover layer 5 is formed of an optically transparent resin, for which a hardening resin cured by ultraviolet rays or radiation is used. The hardening resin has a viscosity of about 1000 to 3000 cps before being cured, preferably about 2000 cps, and has 70% of a light transmittance or greater, preferably 80% or greater, where the hardening resin has a thickness of about 0.1 mm after being cured and is measured by a spectrophotometer at a light wavelength of about 405 nm. The hardening resin is applied over the recording layer 4 by spin coating so that the thickness thereof is about 0.1 mm after being cured, whereby the cover layer 5 is formed.

Next, the fabrication method of the optical information recording medium 1 will be described. First, a polycarbonate disk substrate 2 is formed by injection molding to have a diameter of about 120 mm, a thickness of about 1.1 mm, and a through hole CH in a center part of the disk substrate 2 in which the diameter of the portion from the opening of the hole on one surface to the portion having a depth of about 0.2 mm is about 18.0 mm and the diameter of the other portion is about 15.0 mm. The substrate 2 is formed in such a way that a stamper for forming spiral guide grooves is set in a mold and polycarbonate is injected into the space therebetween. The step part 6 is formed by a mold or a stamper in this process step.

On the area having a radius of about 17.0 mm to about 59.0 mm on the surface on which the diameter of the opening of the through hole CH of the substrate 2 is greater, an Al metal is deposited by sputtering to form the reflective layer 3. Subsequently, a cyanine dye solution is applied over the reflective layer 3 by spin coating to form the recording layer 4.

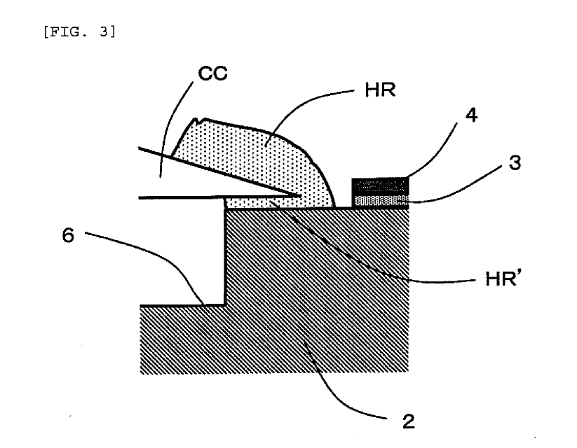

The substrate 2 having the reflective layer 3 and the recording layer 4 thus formed thereon is prepared. As shown in FIG. 2, the substrate 2 is placed on a rotary table of a spin coater (not shown), and a center cap CC having a diameter of about 18.5 mm is set so that the center thereof is matched with the rotation axis of the rotary table to block the through hole CH. In addition, FIG. 2 shows a cross section schematically depicting a right half of the optical information recording medium from the center line thereof. Subsequently, an optically transparent ultraviolet curing resin HR having a viscosity of 2000 cps is discharged from a nozzle NZ, and supplied into the step part 6. At this time, the hardening resin HR is supplied while the rotary table is being rotated at 60 rpm, a relatively low speed. Moreover, when a plurality of the nozzles NZ is provided (preferably, three nozzles or greater), or when the nozzle NZ is moved, the rotary table may be stationary.

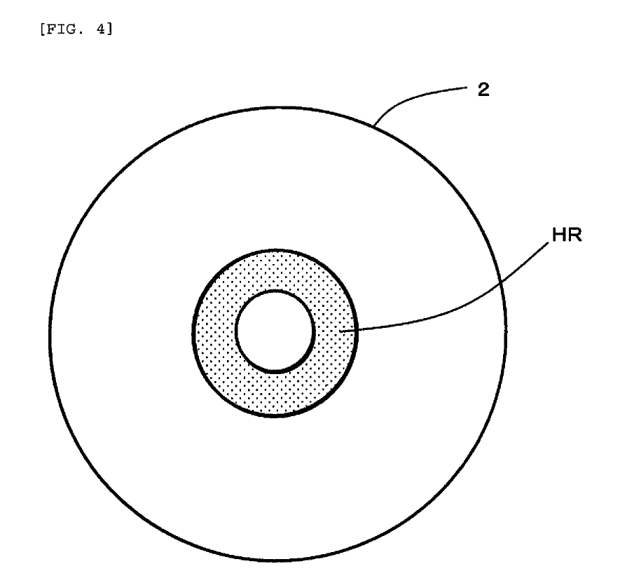

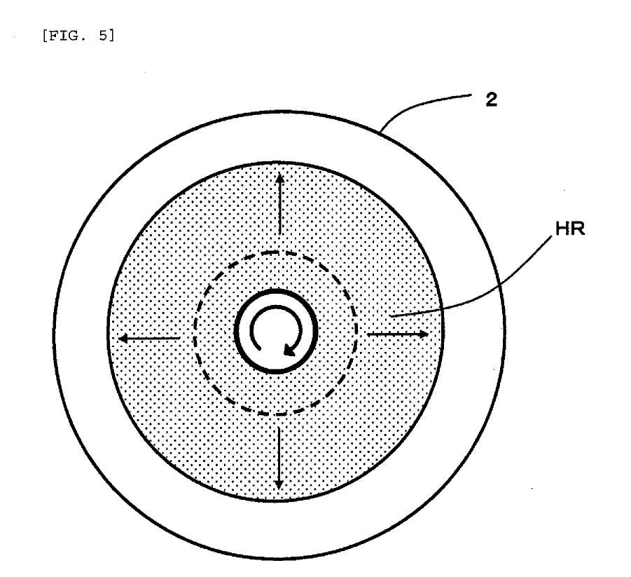

At this time, as shown in FIG. 3, the hardening resin HR partially enters the clearance between the center cap CC and the substrate 2 to form a resin HR′ that wets and extends to the inner track side of the substrate. However, due to the existence of the step part 6, the space between the center cap CC and the substrate 2 is widened to stop capillary action, and thus the expansion of the hardening resin HR′ is blocked by the step part 6. Since the substrate 2 used for the optical information recording medium 1 according to the invention has this advantage, the center cap CC may have a relatively gentle slope, or may be a flat plate in the extreme. In the case of using the center cap CC like this, the supplied hardening resin HR has a reduced flow in the radial direction. Thus, as shown in FIG. 4, the hardening resin HR resides in nearly a circular shape.

After the hardening resin HR in the amount of the required amount+α is supplied, the rotary table is rotated at a high 5000 rpm. Thus, the hardening resin HR is extended to cover the reflective layer 3 and the recording layer 4. At this time, since the centrifugal force is equally applied to the hardening resin HR, as shown in FIG. 5, the hardening resin HR is applied as extended in nearly concentric circles. After the hardening resin HR is applied, ultraviolet rays are applied to cure the hardening resin HR. As discussed above, the cover layer 5 having a thickness of about 0.1 mm is formed. In addition, since the thickness of the cover layer can be controlled by the viscosity of the hardening resin HR and the rotating velocity of the rotary table, and in addition to these, by the acceleration of rotating the rotary table, the conditions can be set freely to make a thickness of about 0.1 mm. The thickness of the cover layer of the optical information recording medium 1 thus obtained has the thickness varied within about ±2 μm.

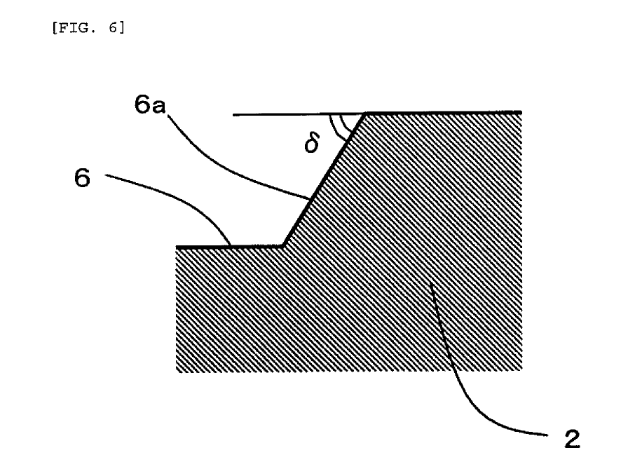

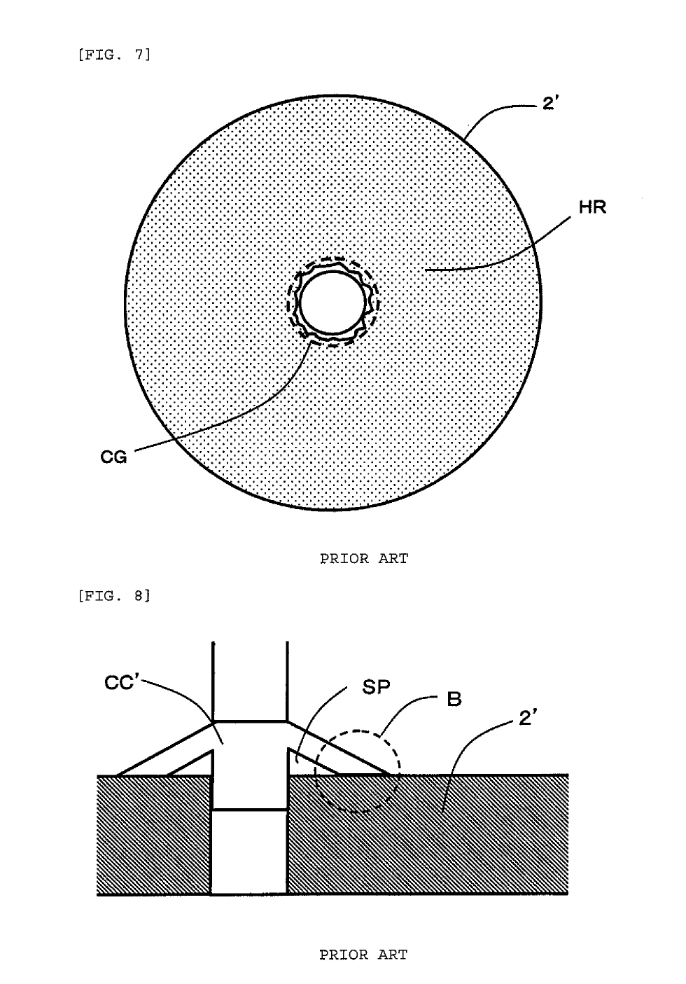

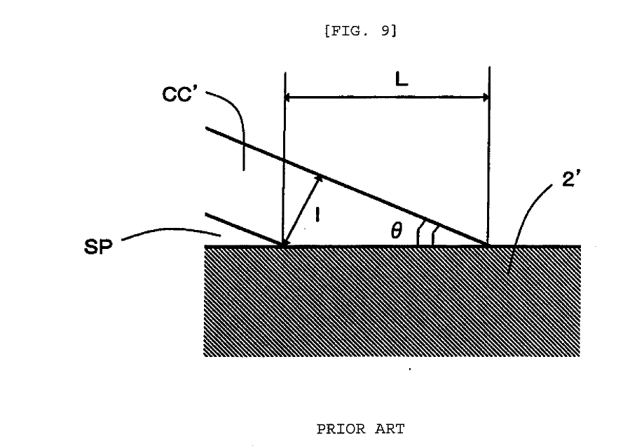

Moreover, preferably, a wall surface 6a of the step part 6 is a vertical surface, but as shown in FIG. 6, it may be a tilted surface. However, since the effect to stop capillary action is made small when the slope angle δ to the horizontal surface is small, preferably, the slope angle δ of the wall surface 6a of the step part 6 is an angle of 45 degrees or greater, more preferably, an angle of 60 degrees or greater.

As discussed above, the embodiment of the invention has been described. The fabrication conditions and various dimensions can be set freely, which can be adjusted properly as long as those are within the scope of the invention.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. An optical information recording medium comprising:
a substrate in a circular shape having a through hole in a center part;
a reflective layer and a recording layer formed on a first surface of the substrate; and
an optically transparent cover layer provided on the surface on which the reflective layer and the recording layer are formed,
wherein the substrate has an inner diameter of an area near an opening of the through hole on the first surface greater than an inner diameter of another portion of the through hole.

2. The optical information recording medium according to claim 1, wherein the area near the opening of the through hole on the first surface is an area having a depth of at most about 0.3 mm from the surface of the substrate.

3. The optical information recording medium according to claim 1, wherein the area near the opening of the through hole on the first surface forms a step shape.

4. The optical information recording medium according to claim 3, wherein a wall surface of the step shape is approximately normal to the first surface of the substrate.

5. The optical information recording medium according to claim 3, wherein a wall surface of the step shape forms an angle greater than 45 degrees with respect to the first surface of the substrate.

6. The optical information recording medium according to claim 3, wherein a wall surface of the step shape forms an angle greater than 60 degrees with respect to the first surface of the substrate

7. A method of fabricating an optical information recording medium, comprising:
providing a substrate in a circular shape having a through hole in a center part and having a reflective layer and a recording layer formed on a first surface of the substrate;
placing a center cap into contact with said substrate, wherein said center portion of said center cap is positioned over the through hole in said substrate, wherein an edge portion of said center cap is in contact with the first surface of said substrate, and wherein an intermediate portion of said center cap between said center portion and said edge portion is positioned over a recess in said first surface surrounding said through hole;
supplying an optically transparent hardening resin to an area near the through hole on the first surface;
rotating the substrate to cover the surface on which the reflective layer and the recording layer are formed with the hardening resin by spin coating; and
curing the hardening resin to form a cover layer.

8. A method of preventing inward migration of resin during spin coating of an optical information recording disk, comprising preventing capillary action on an inner portion of the disk with a recess in a first surface of the disk having a larger diameter than and surrounding a through hole in the center of the disk.
